(19) United States
(12) Patent Application Publication
(10) Pub. No.: US 2009/0021396 A1
(43) Pub. Date: Jan. 22, 2009

(54) Method and Device for Evaluating Distance Measuring Data of a Distance Measuring System of a Motor Vehicle

(76) Inventor: Markus Hedderich, Stuttgart (DE)

Correspondence Address: DREISS, FUHLENDORF, STEIMLE & BECKER, POSTFACH 10 37 62, D-70032 STUTTGART, DE

(21) Appl. No.: 11/918,049

(22) PCT Filed: Mar. 10, 2006
(86) PCT No.: PCT/EP2006/002200

§ 371 Date: Oct. 9, 2007

(30) Foreign Application Priority Data
Apr. 20, 2005 (DE) 10 2005 018 408.1

(51) Int. Cl. G08G 1/054

(52) U.S. Cl. 340/937

(57) ABSTRACT

The invention relates to a method for evaluating distance measuring data of a distance measuring system of a motor vehicle. A camera image (100) of the surroundings of a vehicle which is to be observed is received and distance measuring data from the same surroundings which are to be observed is received by means of the distance measuring system. The camera image (100) is displayed on the display device and distance information (1a′, 1b,2) is integrated into the camera image (100) according to the distance measuring data. According to the invention, a driving path (4a, 4b) of the motor vehicle is determined and, optionally, integrated into the camera image (100).

### DESCRIPTION

The present invention concerns a method for the evaluation of distance measurement data of a distance measuring system in a vehicle, in which a camera image is obtained of an environment of the vehicle being monitored, and in which distance measurement data from the same monitored environment are obtained by means of the distance measuring system, wherein the camera image is displayed on a display unit, and wherein distance information is integrated into the camera image as a function of the distance measurement data.

The present invention furthermore concerns a device for the execution of a method of this kind.

Methods and devices of this kind are known in the art, and superpose, for example, objects and/or obstacles, located in the environment being investigated and detected by means of the distance measuring system, on the camera image in the form of bars, in order to permit a driver of the vehicle, at least to a certain extent, to effect spatial assignment of the objects when observing the camera image. However, apart from the information as to whether an object actually exists in the environment being investigated, these devices and/or methods allow at best, the reading-off of a range of the object in question from the camera image. Further information is not made available by the systems of prior art.

Accordingly it is the object of the present invention to further develop a method and a device of the kind cited above, such that an improved representation of the information determined is achieved, as is a more efficient relay of information to the user.

This object is achieved according to the invention with a method of the kind cited above, in that a driving path of the vehicle is determined and likewise integrated into the camera image.

The driving path describes that region of the environment of the vehicle into which the vehicle is predicted to move, and has—at right angles to a virtual center line—a width that corresponds to the largest width dimension of the vehicle. In this manner, according to the arrangement of the driving path in space, an investigation can be undertaken as to whether or not the motor vehicle is on a collision course with an object located in its environment.

For the driver of a motor vehicle, the integration according to the invention of the driving path into the camera image is very helpful, in order to be able to detect and avoid possible imminent collisions of the motor vehicle with objects in the vehicle environment displayed by the camera image.

If objects are located within the driving path integrated in the camera image, the driver can detect that onward movement with the same parameters, e.g. an unaltered steering angle, will lead to a collision with the object. If no object is located in the spatial region marked by the driving path no collision will ensue in the event of onward movement.

The integration of the driving path into the camera image can, for example, take place by means of a superposition of the driving path, that is to say, a geometrical object representing the driving path, onto the camera image. The superposition can, for example, be effected in that the appropriate video data of the camera image are manipulated directly in a memory provided for this purpose and/or are integrated into the video data stream by a computing unit. Other graphical objects can be integrated into the camera image in the same manner.

In a particularly advantageous embodiment of the present invention, the driving path is dynamically determined as a function of the steering angle and/or a speed and/or of the wheel rotational speeds of individual wheels of the motor vehicle. In this manner, a representation of the driving path that is as accurate as possible can be implemented in each driving situation. The dynamically determined driving path is advantageously likewise dynamically, i.e. as immediately as possible after its recalculation, integrated into the current camera image in order to supply the driver with the most current information at all times.

Data concerning the steering angle and/or the wheel rotational a control unit executing the method according to the invention can obtain speeds, for example, via a data bus provided in the motor vehicle, such as e.g. the CAN-bus of other control units.

In a further very advantageous embodiment of the method according to the invention, the driving path is integrated into the camera image only up to a defined maximum distance from the motor vehicle. As already described, the driving path represents a region predicted to be traversed by the motor vehicle, so that the calculation of the driving path, in particular for large distances from the current position of the motor vehicle, is less meaningful because of changes in the driving parameters such as e.g. an alteration of the steering wheel position, that is to say, steering angle. With too long a driving path it is less probable that this specifies the actual track of the motor vehicle, and excessively long driving paths also lead to unnecessary information in the camera image, which could distract the driver from the near region directly proceeding past the motor vehicle. The limitation according to the invention of the length of driving path integrated into the camera image is therefore very advantageous. For example, a maximum distance in the form of a parameter can be prescribed that specifies the maximum length of the driving path to be integrated into the camera image. It can furthermore be advantageous to select this maximum distance as a function of the vehicle speed.

In a further very advantageous embodiment of the method according to the invention, the driving path integrated into the camera image does not end abruptly in the region of the defined maximum distance, rather continuously, in that it is, for example, faded out over a certain distance. The fading out can, for example, take place by means of a varying contrast of the geometrical object representing the driving path in the camera image over the distance prescribed for this purpose.

In general, different brightness values and/or contrast values and/or color values can be assigned to the driving path for integration into the camera image, preferably as a function of a driving state of the motor vehicle and/or as a function of distance measurement values.

In a further variant of the method according to the invention, for at least two different regions of the environment being monitored, distance measurement data assigned to these respective regions are obtained with the distance measuring system. In this manner, separate distance information can be imaged for the individual regions, and more precise information concerning the motor vehicle environment can thereby be supplied and also integrated into the camera image.

In a particularly advantageous further variant of the method according to the invention, provision is made that the at least two regions extend along a width of the environment being monitored, that is to say, of the camera image. In this manner it is possible to selectively determine objects and their distance from the vehicle that e.g. are located only in the region of the right-hand or left-hand side of the motor vehicle, and thus take up only a part of the width of the driving path.

Exceptionally advantageously, these at least two regions correspond to the registration regions of the distance sensors integrated in the distance measuring system, wherein, in particular these distance sensors work in accordance with the ultrasound principle or the radar principle.

Likewise very advantageous is furthermore integration according to the invention of the distance information corresponding to the regions into the camera image as a function of the distance measurement data assigned to the respective regions. In this manner, the distance information can directly specify information concerning the distance measurement data assigned to it by its graphical representation in the camera image.

It is also particularly advantageous to integrate the distance information into the camera image in the form of geometrical objects, in particular in the form of rectangles and/or trapezoids. Such geometrical objects can be generated in a simple manner by a computing unit that is processing the camera image, and integrated i.e. superposed, onto the camera image. Moreover, because of their simple regular shapes, these geometrical objects differ clearly from the objects included in the camera image from the monitored environment, so that the driver can easily interpret and accordingly evaluate the distance information as such.

It is also very advantageous to select the size of the geometrical objects as a function of the respective distance measurement data, as a result of which the distance measurement data can be made available to the driver in an intuitive manner in the camera image.

Furthermore, different brightness values and/or contrast values and/or color values can be assigned to the distance information corresponding to the various regions. This can serve the purpose of ensuring that the various regions—in addition to their spatial arrangement in the camera image—can be visually differentiated from one another, in that, for example, different basic colors are assigned to them. Moreover an allocation of different color values can take place e.g. as a function of the distance measurement values assigned to the regions, so that a clear representation is likewise guaranteed.

A further exceptionally advantageous embodiment of the present invention is characterized in that distance information that is assigned to regions of the environment being monitored lying outside the driving path, is integrated into the camera image and represented in the latter in a different manner than distance information that is assigned to regions of the environment being monitored lying inside the driving path. In this manner, a simple ability to differentiate between the various items of distance information is accordingly guaranteed, as to whether or not they are to be used for the assessment of possible collisions by virtue of their arrangement within the driving path.

In an exceptionally advantageous manner, it is proposed that the distance information that is assigned to regions of the environment being monitored lying outside the driving path is integrated into the camera image and represented in the latter less clearly, for example with low contrast, and that the distance information that is assigned to regions of the environment being monitored lying inside the driving path is integrated into the camera image and represented in the latter clearly, for example with high contrast. It is thereby ensured that the more important information for safe collision-free travel, namely the distance information from regions within the driving path, can be registered better from the camera image than less important information, namely the distance information from regions outside the driving path.

A respective differentiation between the more important and/or less important distance information is achieved according to the invention, for example, in that the distance information is integrated into the camera image in a different manner, in particular with different brightness values and/or contrast values and/or color values, depending on the region of the environment being monitored to which it is assigned.

In a further embodiment of the method according to the invention, further distance information is integrated into the camera image, in particular distance information that is not dependent on the distance measurement data. Such distance information displays a distance from the motor vehicle in the camera image, preferably in steps that are equidistant from one another of, for example, half a meter, and serves as an orientation aid to the driver for the assessment of the individual distances to objects in the monitored environment.

According to the invention, it is also possible to only integrate distance information into the camera image if corresponding values of the distance measurement data lie within a defined range of values. On the basis of their distance, objects estimated to be unimportant, or possibly implausible, can thereby be excluded from any representation in the camera image, which further increases the clarity of the information presented by the camera image.

It is furthermore conceivable that the distance measurement data is obtained alternatively or additionally to sensor systems that are ultrasound-based or radar-based by means of a camera system, in particular a stereo camera system.

A device according to claim 19 is specified as a further achievement of the object of the present invention.

Further features, advantages, and embodiments of the present invention are specified in the following description of the figures, with reference to the drawing, wherein:

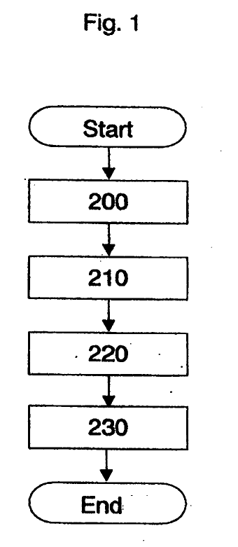

FIG. 1 shows a simplified flow diagram of an embodiment of the method according to the invention,

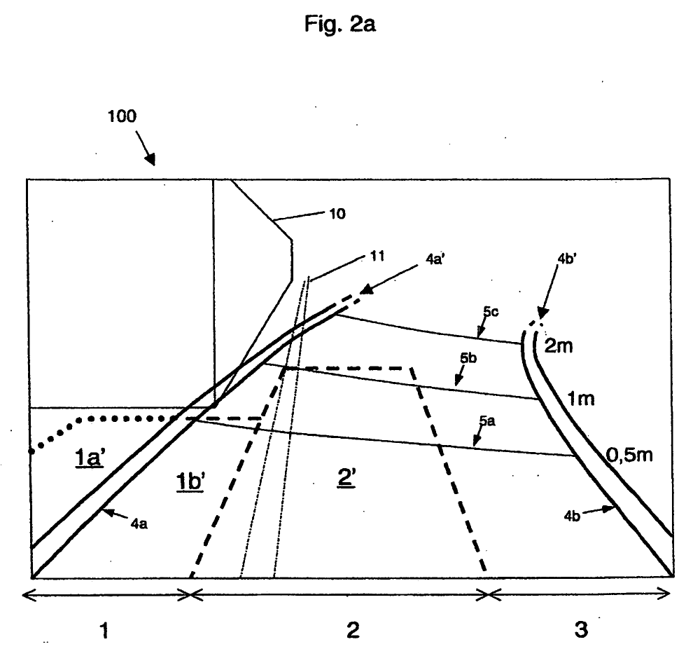

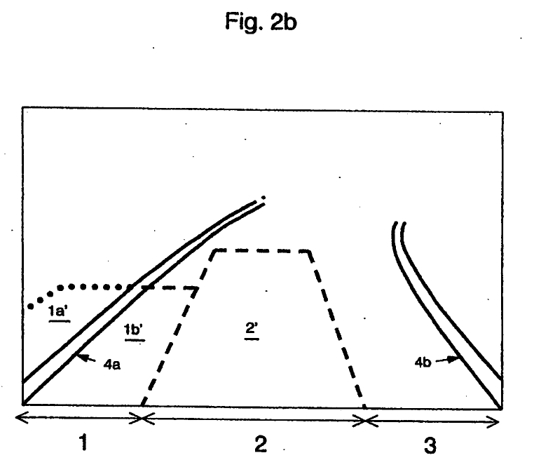

FIG. 2a shows a camera image obtained with the method according to the invention, and

FIG. 2b shows a simplified version of the camera image from FIG. 2a.

In the method according to the invention in accordance with FIG. 1, in a first step 200, a camera is initially obtained from an environment of a motor vehicle being monitored. Such a camera image 100 is shown in an exemplary and greatly simplified manner in FIG. 2a.

The camera image 100 depicted in FIG. 2a shows a scene, such as is obtained with a motor vehicle reversing camera known per se, of a region lying behind the motor vehicle. Relative to a forward direction of travel of the motor vehicle, projecting from the plane of the drawing of FIG. 2a, an obstacle 10 is located in the environment on the right-hand side behind the motor vehicle, i.e. on the left-hand side above in FIG. 2a; this obstacle can take the form, for example, of another e.g. parked, motor vehicle, which is standing in a parking zone marked off by a side strip 11.

Here the side strip 11 separates the parking zone arranged to its left-hand side in FIG. 2a from a road skirting this parking zone, which extends parallel to the side strip 11 and on the right-hand side of it in the camera image 100 according to FIG. 2a. The scene as shown ensues, for example, when the subject vehicle is leaving a parking space lying to the left-hand side of the side strip 11 in FIG. 2a, that space being bounded at the rear, i.e. opposite to the forward direction of travel, by the parked motor vehicle 10.

To support the driver of the motor vehicle, the method according to the invention integrates a driving path 4a, 4b into the camera image 100, cf. step 210 in FIG. 1. The driving path 4a, 4b describes that region of the environment of the vehicle in which the vehicle is predicted to move onward—in the context of a presently predicted rearward movement in the course of exiting from the parking space—and has—at right angles to its virtual central line—a width that corresponds to the largest width dimension of the vehicle. This width of the driving path 4a, 4b is specified by the curves 4a, 4b that are superimposed onto the camera image 100. The color and/or brightness and/or contrast of the curves 4a, 4b are selected such that the driving path 4a, 4b stands out well from the camera image 100, in order to enable simple visual evaluation.

The driving path 4a, 4b is determined from the geometry of the motor vehicle, and also from the speed and/or individual wheel rotational speeds of the motor vehicle, as well as a steering angle. According to the invention, the driving path 4a, 4b is superimposed only up to a defined maximum distance, wherein the regions 4a′, 4b′ of the driving path 4a, 4b located in the region of the maximum distance are not faded out abruptly, or are not even superimposed onto the camera image 100. The end regions 4a′, 4b′ of the driving path 4a, 4b are preferably displayed in the camera image 100 by an appropriate distribution of color and/or brightness and/or contrast that is dependent on the distance from the motor vehicle. This situation is symbolized in FIG. 2a by the continuation of the curves 4a, 4b in the form of dashed lines 4a′, 4b′.

With the aid of the driving path according to the invention 4a, 4b, the driver of the motor vehicle can detect on the camera image 100 displayed via a display unit (not depicted) that the current course of the motor vehicle will lead to a collision with the parked vehicle 10, since the left-hand boundary 4a of the driving path 4a, 4b intersects the parked vehicle.

For improved orientation in the method according to the invention, distance information in the form of the curves 5a, 5b, 5c connecting the curves 4a, 4b of the driving path 4a, 4b are integrated into the camera image 100 in addition to the driving path 4a, 4b. This distance information 5a, 5b, 5c is preferably arranged in steps that are arranged equidistant to one another, or also as a function of distance, for example, each step is spaced half a meter from the next. By means of this distance information 5a, 5b, 5c, the driver can clearly see from the camera image 100 that at a distance of 0.5 m to the rear of the motor vehicle the left-hand curve 4a of the driving path 4a, 4b has a point of intersection with the obstacle 10.

Furthermore it can be seen from this distance information 5a, 5b, 5c that the driving path 4a, 4b is depicted up to a maximum distance of approximately 2 m calculated from the rear of the vehicle.

In addition to the camera image 100 and the driving path 4a, 4b distance measurement data are obtained in step 220 of the method according to the invention in accordance with FIG. 1 from the same environment of the motor vehicle as is shown in the camera image 100, i.e. the distance measurement data contain information concerning objects located behind the motor vehicle and their distance from the motor vehicle.

For this purpose, a distance measuring system known per se, based on ultrasound sensors, or radar sensors, or an optical system, in particular a stereo camera system can be used.

In the present example, the distance measuring system has a plurality of ultrasound sensors, which register an environment lying behind the motor vehicle in three regions defined by the registration regions of the ultrasound sensors.

These regions are symbolized in FIG. 2a by the double-headed arrows 1, 2, 3, the ultrasound sensors register i.e. the rearward environment of the motor vehicle over the whole width shown in the camera image 100.

In the present example, the distance measurement data supplied by the ultrasound sensors is integrated into the camera image 100 in the form of distance information 1a′, 1b′, 2′. Here, as can be seen from FIG. 2a, the distance information 1a′, 1b′, 2′ is represented as geometrical objects, in particular as rectangles or trapezoids.

In both regions 1 and 2 objects that are present are detected by the distance measuring system, and a corresponding distance to the objects is specified in terms of the size, that is to say, the height of the rectangles 1a′, 1b′, 2′. Here, the parked motor vehicle 10 represents the object detected in region 1 and in region 2. Region 3 has no rectangle, because no object has been detected in this region.

In order to be able to better assess the object 10 registered by the distance measuring system in accordance with FIG. 2a as to its significance regarding a safe and collision-free movement of the motor vehicle, the distance information 1a′, 1b′, 2′ shown in the camera image 100 is analyzed as a function of its position relative to the driving path 4a, 4b and is differently represented accordingly, as takes place in step 230 of the method according to the invention, cf. FIG. 1. Thus, in particular in region 1 (FIG. 2a), the distance information 1a′, corresponding to a region lying outside the driving path 4a, 4b, is represented in a different manner than the distance information 1b′, corresponding to a region lying inside the driving path 4a, 4b; this is symbolized in FIG. 2a by the dotted lines used to mark out the distance information 1a′ and the dashed lines used to mark out the distance information 1b′.

With a colored camera image 100 that distance information 1b′, 2′ whose regions lie inside the driving path 4a, 4b, can, in particular, be clearly emphasized.

In general, the distance information assigned to the different regions 1, 2, 3 according to the invention can be divided into a plurality of, at least two, parts such as e.g. 1a′, 1b′, in order to enable a particular emphasis of the more important of the two parts. FIG. 2b shows a further simplified representation of the camera image 100 from FIG. 2a, in which the distribution according to the invention of the distance information 1a′, 1b′ as a function of its position relative to the driving path 4a, 4b can be particularly well detected. For the appropriate partitioning of the distance information 1a′, 1b′, the data used for the calculation of the driving path 4a, 4b can be called upon.

Particularly advantageous is utilization of a semi-transparent representation for the less important distance information 1a′, while the more important distance information 1b′, 2′ is represented non-transparently.

In general, the geometrical objects that represent the driving path 4a, 4b and the distance information 1a′, 1b′, 2′, 5a, 5b, 5c in the camera image 100 can be represented with different brightness values and/or contrast values and/or color values in the camera image 100 in order to emphasize the respective objects according to their importance.

With the aid of the distance information 1a′, 1b′, 2′ integrated into the camera image 100 according to the invention, the driver is effectively made aware of any obstacles present within the driving path 4a, 4b.

1-19. (canceled)

20. A method for the evaluation of distance measurement data of a vehicle distance measuring system, the method comprising the steps of:
a) obtaining a camera image of an environment being monitored of the vehicle;
b) obtaining distance measurement data from the distance measuring system of the environment being monitored;
c) determining a driving path of the motor vehicle;
d) displaying the camera image on a display unit;
e) integrating distance information into the camera image as a function of the distance measurement data; and
f) integrating the driving path into the camera image.

21. The method of claim 20, wherein the driving path is dynamically determined as a function of a steering angle, a speed, and/or wheel rotational speeds of individual wheels of the motor vehicle.

22. The method of claim 20, wherein the driving path is integrated into the camera image only up to a defined maximum distance from the motor vehicle.

23. The method of claim 22, wherein the driving path integrated into the camera image does not end abruptly in a region of defined maximum distance, rather is continuously faded out over a certain distance.

24. The method of claim 20, wherein different brightness values, contrast values and/or color values are assigned to the driving path for integration into the camera image or are assigned as a function of a driving state of the motor vehicle and/or as a function of distance measurement values.

25. The method of claim 20, wherein the distance measuring system obtains distance measurement data for at least two different regions of the environment being monitored.

26. The method of claim 25, wherein the at least two regions extend along a width of the environment being monitored in the camera image.

27. The method of claim 25, wherein the regions correspond to registration regions of distance, ultrasound, or radar sensors integrated in the distance measuring system.

28. The method of claim 25, wherein distance information corresponding to the regions is integrated into the camera image as a function of the distance measurement data assigned to a respective region.

29. The method of claim 28, wherein distance information is integrated into the camera image in a form of geometrical objects, rectangles, and/or trapezoids.

30. The method of claim 29, wherein a size of the geometrical objects is selected as a function of respective distance measurement data.

31. The method of claim 28, wherein different brightness values, contrast values, and/or color values are assigned to the distance information corresponding to the regions or are assigned as a function of the distance measurement values associated with the regions.

32. The method of claim 20, wherein distance information that is assigned to regions of the environment being monitored lying outside the driving path are integrated into the camera image and represented therein in a different manner than distance information that is assigned to regions of the environment being monitored lying inside the driving path.

33. The method of claim 32, wherein distance information that is assigned to regions of the environment being monitored lying outside the driving path is integrated into the camera image and represented therein less clearly or with low contrast, and distance information that is assigned to regions of the environment being monitored lying inside the driving path is integrated into the camera image and represented in the latter clearly or with high contrast.

34. The method of claim 20, wherein distance information is integrated into the camera image in a different manner with different brightness values, contrast values, and/or color values, depending on an associated region of the environment being monitored to which it is assigned.

35. The method of claim 20, wherein further distance information or distance information that is not dependent on the distance measurement data are integrated into the camera image to specify a distance from the motor vehicle or to specify a distance from the vehicle in steps that are equidistant from one another or of half a meter.

36. The method of claim 20, wherein distance information is only integrated into the camera image if corresponding values of the distance measurement data lie within a predetermined range of values.

37. The method of claim 20, wherein the distance measurement data are obtained with a camera system or with a stereo camera system.

38. A device for execution of the method of claim 20.
